(19) United States
(12) Patent Application Publication
(10) Pub. No.: US 2016/0093142 A1
(43) Pub. Date: Mar. 31, 2016

(54) METHOD AND SYSTEM FOR A GAMING PEDESTAL ASSEMBLY

(71) Applicant: Video Gaming Technologies, Inc., Franklin, TN (US)

(72) Inventors: William Douglas Lamb, Eagleville, TN (US); Daniel William Rice, Thompson Station, TN (US); Victor Brent McClearen, Cookeville, TN (US); Charles Stanley Curbbun, Encinitas, CA (US); Arvin Grande Abadilla, Encinitas, CA (US); Matthew Kranz, Encinitas, CA (US); Julian Groeli, San Diego, CA (US); Blake Chuanlun Wang, San Diego, CA (US); Jin Chen, Carlsbad, CA (US); William John Leach, San Diego, CA (US)

(21) Appl. No.: 14/498,586

(22) Filed: Sep. 26, 2014

(51) Int. Cl. G07F 17/32; G07F 17/34

(52) U.S. Cl. CPC G07F 17/3213; G07F 17/34

(57) ABSTRACT

A gaming machine includes a base including a width having a first length dimension and a depth having a second length dimension and a columnar pedestal extending vertically from the base, the pedestal including a width having a third length dimension and a depth having a fourth length dimension, the first length dimension being greater than the third length dimension, the second length dimension being greater than the fourth length dimension. The gaming machine also includes a game cabinet including a gaming display including at least one of a single video display panel, a plurality of video display panels, and a combination of mechanical reels and one or more video display panels and a mating flange configured to releasably mount to a complementary pedestal flange positioned at an upper edge of the pedestal. The gaming machine further includes one or more mating plugs.

### BACKGROUND

This description relates to gaming machines, and, more particularly, to a method and system for enhancing player comfort and ergonomics in gaming machines.

Gaming machines have evolved to a substantially consistent form due to interchangeability and standardization considerations. For example, button layouts follow a standard linear arrangement in which players' must adjust their reach to accomplish different actions. Rather than assuming a more ergonomic configuration that is less fatiguing to players, buttons of gaming machines are arranged at consistent intervals in a straight line pattern. Additionally, gaming cabinets have a footprint at floor level that is either similar to and that exceeds the dimensions of the game itself Often, gaming machines are placed on box stands to elevate them to a consistent height. However, the box stands also extend to a footprint that meets or exceeds the dimensions of the game. Players at such gaming machines are constantly at odds of being near enough to the machine to comfortably reach the game buttons, but far enough away from the gaming machine to have room to place their feet in front of them. Placement of the button panel or button deck is generally fixed on the front of the cabinet and is not adjustable to facilitate game play or player comfort.

Moreover, many gaming machines have player tracking modules that include a card reader and dedicated display. Often such player tracking modules appear to be retrofit devices placed inconsistently at various locations on the front of the gaming machine. Typical gaming machine player tracking modules do not have a lighted bezel to assist in locating the player tracking module and those that do, only light up to indicate that a player tracking card has been read properly or has not been read properly by the player tracking card reader.

Value acceptors and printers of the gaming machine are typically located inside the gaming machine cabinet and access slots for passing items from the player to the value acceptor or to the player from the printer are typically separated and positioned inconsistently on the front of the gaming machine. In some cases, value acceptors and printers are positioned adjacently with separate access slots for accessing the devices. In still other cases, value acceptor and the printer share a common slot. However, it is often difficult to differentiate the value acceptor slot from the printer slot and errors in trying to feed currency or vouchers into the printer slot occur regularly.

Such discomforts and poor ergonomics affect player satisfaction with the gaming machine and the gaming experience and may affect revenues of the affected machines.

### BRIEF DESCRIPTION

In one aspect, a gaming machine includes a base including a width having a first length dimension and a depth having a second length dimension and a columnar pedestal extending vertically from the base, the pedestal including a width having a third length dimension and a depth having a fourth length dimension, the first length dimension being greater than the third length dimension, the second length dimension being greater than the fourth length dimension. The gaming machine also includes a game cabinet including a gaming display including at least one of a single video display panel, a plurality of video display panels, and a combination of mechanical reels and one or more video display panels and a mating flange configured to releasably mount to a complementary pedestal flange positioned at an upper edge of the pedestal. The gaming machine further includes one or more mating plugs configured to engage a complementary one or more mating plugs positioned proximate the mating flanges, the mating plugs configured to join respective signal and power conduits between the pedestal and the game cabinet.

In another aspect, a gaming machine includes a gaming display including a display frame surrounding a display area, a first side panel device coupled to a first side of the frame and a second side panel device coupled to a second side of the frame opposite the first side, the first and second side panels including a touchscreen video display panel. The gaming machine also includes a beacon light including a planar substrate including an outer peripheral edge, a light source configured to illuminate an interior of the substrate through at least a portion of the outer peripheral edge, a first transparent hemispherical member including an edge configured to mate to the outer peripheral edge, and a second hemispherical member including an edge configured to mate to the outer peripheral edge, the second hemispherical member formed of a material that is at least one of translucent and opaque.

In a further aspect, a gaming machine system includes a pedestal including a button deck adjustably coupled to the pedestal, the button deck including a pair of extendable arms, each arm coupled at one end to the pedestal and at a second end to the button deck, the button deck extendable away from and towards the pedestal, a player tracking card reader positioned within the button deck and accessible through a slot in a front edge of the button deck, and a plurality of interchangeable gaming displays selectable such that one of the plurality of gaming displays is mounted to the pedestal at a time. The plurality of gaming displays including a single video display panel oriented in at least one of a portrait and a landscape orientation, a plurality of video display panels oriented in at least one of a portrait and a landscape orientation, and a combination of mechanical reels and one or more video display panels. The gaming machine also includes a mating flange configured to releasably mount to a complementary pedestal flange positioned at an upper edge of the pedestal, and one or more mating plugs configured to engage a complementary one or more mating plugs positioned proximate the mating flanges, the mating plugs configured to join respective signal and power conduits between the pedestal and the game cabinet, and a player tracking display area of the plurality of interchangeable gaming displays configured to display player tracking information, the player tracking display area displayed on one of the video display panels.

### BRIEF DESCRIPTION OF THE DRAWINGS

FIGS. 1-9 show example embodiments of the method and apparatus described herein.

FIG. 1 is a perspective view of a gaming machine in accordance with an example embodiment of the present disclosure.

FIG. 2 is a perspective view of gaming machine in another example embodiment of the present disclosure, in which the column shown in FIG. 1 is shortened as compared to the column shown in FIG. 2.

FIG. 3 is a side elevation view of the column and three examples of the game cabinet.

FIG. 4 is an illustration of configurations of the game cabinet in accordance with example embodiments of the present disclosure.

FIG. 5 is a perspective view of a lower portion of the game cabinet in accordance with an example embodiment of the present disclosure.

FIG. 6 is an enlarged perspective view of the button deck shown in FIGS. 1 and 2.

FIG. 7 is a perspective view of the first user interface shown in FIGS. 1 and 2.

FIG. 8 is an illustration of embodiments of connections of the button deck to the column.

FIG. 9 is a perspective view of the beacon light shown in FIGS. 1 and 2.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The following detailed description illustrates embodiments of the disclosure by way of example and not by way of limitation. It is contemplated that the disclosure has general application to gaming machine embodiments providing player comfort and ergonomic considerations in industrial, commercial, and residential applications.

The following description refers to the accompanying drawings, in which, in the absence of a contrary representation, the same numbers in different drawings represent similar elements.

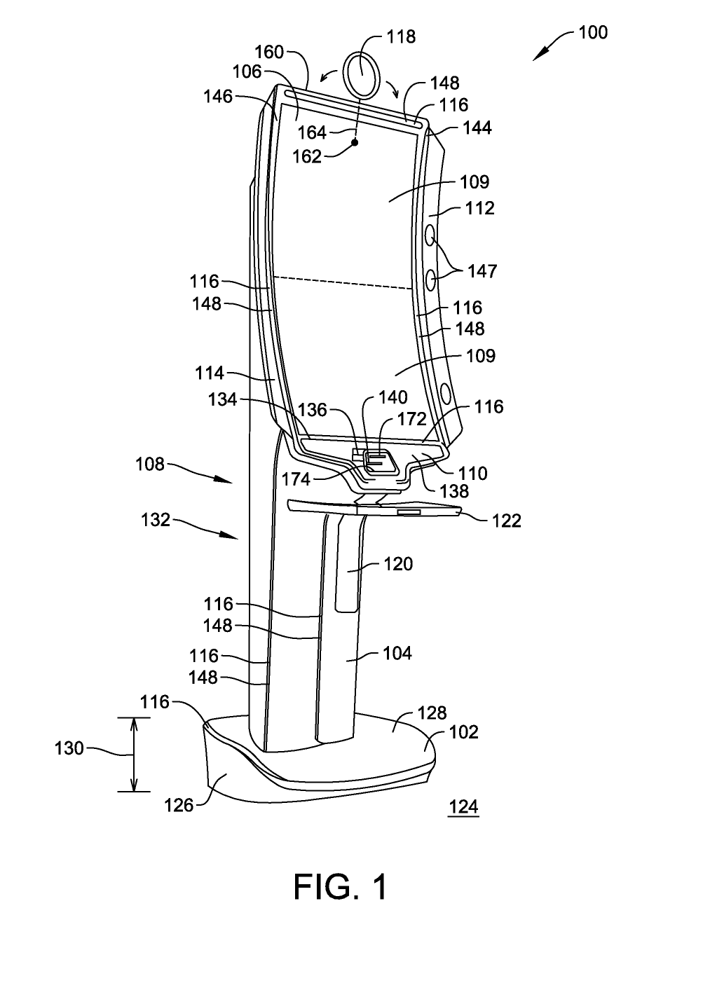

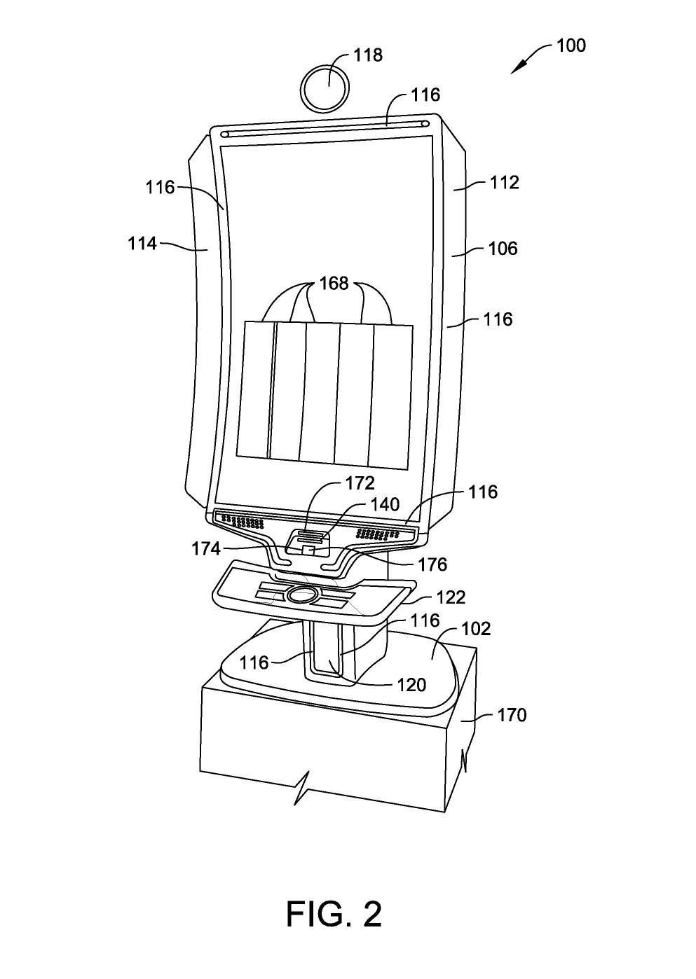

FIG. 1 is a perspective view of a gaming machine 100 in accordance with an example embodiment of the present disclosure. FIG. 2 is a perspective view of gaming machine 100 in another example embodiment of the present disclosure, in which column 104 is shortened as compared to column 104 shown in FIG. 1. A shorter column 104 permits installation that is compatible with, for example, other gaming machines (not shown) in a banked arrangement where the other gaming machines are shorter. In the example embodiment, gaming machine 100 includes a base 102 and a column 104 supported by base 102. A game cabinet 106 is coupled to an upper portion 108 of column 104. Game cabinet 106 includes one or more video display panels 109, a plurality of auxiliary devices, such as, but, not limited to a first user interface 110, a first side panel 112, a second side panel 114, edge lighting 116, a beacon light 118, and a courtesy light 120. Gaming machine 100 also includes a button deck 122 adjustably coupled to column 104, game cabinet 106, and/or first user interface 110.

In the example embodiment, base 102 is configured to rest on or be coupled to a lower horizontal surface such as, but, not limited to, a floor 124. Base 102 includes one or more vertically upwardly extending sidewalls 126, which may include straight panels, and/or curved and contoured panels, such as, but, not limited to a circular, oval, oblong, and/or irregularly curved cross-section. Base 102 includes an upper surface 128 configured to fair base 102 by producing a closed smooth outline, support column 104, and/or provide a resting place for a user's feet. Accordingly, upper surface 128 may include a smooth, glossy, or rough surface texture. Upper surface 128 may be angled with respect to floor 124 to facilitate providing a foot rest or to inhibit a placement of, for example, beverage containers on upper surface 128. A height 130 of base 102 may be set at various fixed dimensions or may adjustable to various dimensions. The dimensions may be selected to accommodate a particular installation and base 102 may be interchangeable with other bases 102 to facilitate relocating gaming machine 100 in different locations in an establishment. Height 130 may be adjustment only by the establishment or also by the user for comfort, ergonomic considerations, preference, and/or ease of operating gaming machine 100.

Column 104 is a rigid, relatively slender, upright support, composed of relatively few components that extends vertically between base 102 and game cabinet 106. In various embodiments, column 104 includes a cylindrical or polygonal shaft 132. Column 104 houses various components and conduits that are configured to support the operation of gaming machine 100 and its integration into a larger operation and control network (not shown), in which gaming machine 100 is in communication.

Column 104 and base 102 are configured to be standard across many embodiments of game cabinet 106. In various embodiments, and as described below, game cabinet 106 is configured to include a single video display panel 109, which may have a horizontal, a vertical, or combination concavely curved aspect. Game cabinet 106 is also configured to include a plurality of video display panels 109 adjacently tiled or overlapping. In another embodiment, game cabinet 106 is configured to include one or more mechanical reels 168. Column 104 includes power supplies, controllers, servers, cabling, connectors and conduits to support operation of gaming machine 100. Each embodiment of game cabinet 106 includes complementary cabling, connectors and controllers to facilitate interchangeable operation with a single column 104. Likewise, column 104 may include several embodiments based on a height of column 104 and/or a height of base 102 or a height of a platform 170 on which base 102 is mounted. Base 170 may be part of a cluster of banked gaming machines of which gaming machine 100 is a part.

Game cabinet 106 includes one or more video display panels 109. In various embodiments, one or more video display panels 109 are configured to display only game-related information. In other embodiments, one or more video display panels 109 are configured to display other than game-related information and game-related information simultaneously or alternately. One or more video display panels 109 may comprise, for example, a TFT LCD (Thin-Film-Transistor Liquid Crystal Display) or an OLED (Organic Light Emitting Diode) display, or other appropriate display technology. In the example embodiment, one or more video display panels 109 comprise a single monolithic display screen. In various embodiments, one or more video display panels 109 comprise a plurality of video display screens. In other embodiments, the plurality of display screens are adjacently tiled to give the appearance of being a single video display screen. In other embodiments, the plurality of display screens are tiled with a border or spacing surrounding at least a portion of one or more of the plurality of display screens. Additionally, one or more video display panels 109 may comprise a concavely curved transparent window with a plurality of flat panel video display screens arranged behind the window on the convex side of the window. The flat panel display screens may be adjacently tiled with respect to each other or may be overlapping with a portion of one flat panel display screens in front or behind another of the flat panel display screens.

Game cabinet 106 is positionable in a portrait and/or landscape orientation and may include a combination of game types, for example, but not limited to a single video display panel, multiple video display panels tiled or overlapping in the vertical and/or horizontal directions, or may include mechanical reels 168 and video display panels 109.

In the example embodiment, first user interface 110 is mounted to column 104 proximate a lower edge 134 of game cabinet 106. First user interface 110 typically includes a value acceptor 136, which may include a paper acceptor for bills of currency and currency vouchers. In various embodiments, value acceptor 136 is configured to receive payment cards, such as, but, not limited to credit cards, debit cards, and prepaid cards. Value acceptor 136 is positioned behind a front bezel 138 of first user interface 110 aligned with a slot 140. A printer 142 (not shown in FIGS. 1 and 2) configured to print and dispense currency vouchers is also positioned behind front bezel 138 and also aligned with slot 140 such that slot 140 may be used for receiving paper and cards to be routed to value acceptor 136 and for dispensing currency vouchers, receipts, and coupons from printer 142.

In various embodiments, value acceptor 136 includes a second slot 172 configured to dispense paper from printer 142 while slot 140 is configured to receive paper (currency bills, vouchers, etc.) and cards (credit cards, debit cards, etc.). In the example embodiment, slot 140 is configured to receive the paper and cards horizontally and first user interface 110 includes a flat receiving surface 174 to facilitate alignment and translation of the paper and/or cards into slot 140. In the example embodiment, slot 172 is oriented in a downward slope an angle β from an interior of game cabinet 106 out towards the user. In various embodiments, angle β is an angle of between 0° and 90° with respect to horizontal. Such a configuration permits an appearance of the material from printer 142 exiting the same location as the paper and/or cards are inserted into slot 140 without the possibility of inserting the paper and/or bills into slot 172.

First user interface 110 also includes a graphical output device 176, which may include a video display screen or an array of lights configurable to coordinate their operation to provide various indications to the user. For example, graphical output device 176 may provide various hints as to an action of the user expected by gaming machine 100. In one state of gaming machine 100, gaming machine 100 may be expecting the user to insert value items into value acceptor 136. Graphical output device 176 may indicate such expectation by generating an arrow object (not shown in FIGS. 1 and 2) pointing toward slot 140. The arrow object may be static, flashing, or indicative of motion by a coordination of sequentially lighting certain ones of the lights. Likewise, in a different state of gaming machine 100, gaming machine 100 may be printing from printer 142. Graphical output device 176 may then indicate an arrow object pointing outwardly from slot 172, either statically or dynamically.

First side panel 112 is hingedly coupled to game cabinet 106 along a first vertical side 144, in some embodiments. First side panel 112 may alternatively be fixedly mounted to first vertical side 144. In one embodiment, first side panel 112 is coupled to an electric motor (not shown) through a linkage (not shown). The electric motor is controlled by gaming machine 100 and/or the user to rotate through an angle a (not shown) of approximately −90° (flat along a side of game cabinet 106) to +45° (angled toward the user when seated in front of gaming machine 100) with respect to a face of game cabinet 106. In various embodiments, first side panel 112 includes one or more speakers 147 configured to generate sounds related to gaming machine 100.

First side panel 112 may also be configured with a flexible display, which may be backlit or include video display elements including, in some embodiments a touchscreen capability. During operation, first vertical side 144 may receive tactical indications from the user and respond with visual indications related to game play of independent of game play on gaming machine 100.

Second side panel 114 is complementary to first side panel 112 and is coupled to game cabinet 106 along a second vertical side 146.

Edge lighting 116 includes an elongate light transmitting member 148 extending through grooves in various surfaces of game cabinet 106, column 104 and/or base 102. In various embodiments, light transmitting member 148 includes a plastic, polymer, glass, or other light transmissive material configured to receive light from a light source positioned in a single position along a predetermined portion of light transmitting member 148 or from multiple locations across an entire length of light transmitting member 148. Moreover, light transmitting member 148 may include the light source within light transmitting member 148 or light transmitting member 148 may use light emitted from an external source, direct the light to various locations along the length of light transmitting member 148 where it is allowed to emit from light transmitting member 148. For example, light transmitting member 148 may comprise a fiber or plastic rope that does not exhibit total internal reflection properties, but, rather light entering an end of light transmitting member 148 is transmitted down its length with a portion of the light being emitted substantially evenly along the length.

In one embodiment, beacon light 118 is configured to traverse linearly across an upper edge 160 of game cabinet 106. In various embodiments, beacon light 118 revolves at least partially about a pivot point 162 and coupled to a linkage or arm 164. In some embodiments, an electric motor controls the movement of beacon light across upper edge 160. For example, the electric motor may control the linear translation of beacon light 118 across upper edge 160 or through an arc about pivot point 162.

A courtesy light 120, which may also be activated to attract users to gaming machine 100 or to add excitement during game paly, is used to provide lighting for entering the vicinity of gaming machine 100 by the user.

In various embodiments, button deck 122 is mounted to column 104 and is controlled through a gaming machine 100 controller (not shown in FIGS. 1 and 2). In one embodiment, button deck 122 is configured to translate with respect to column 104 in a single direction, for example, towards and away from column 104. In some embodiments, the translation is controlled manually by the user, automatically by a motor, or combinations thereof. For example, when gaming machine 100 detects a user entering a proximity of gaming machine 100, button deck 122 may be commanded to translate in either direction to indicate to the user that button deck 122 is movable. The user may then adjust button deck 122 manually by hand, manually through operation of a switch controlling the button deck motor, or allow button deck 122 to be controlled automatically by gaming machine 100. The user may also turn off the automatic translation feature using an override switch (not shown). Button deck 122 may be configured to translate in a plurality of directions and/or rotate around a plurality of axes to suit the user's comfort and ergonomic control.

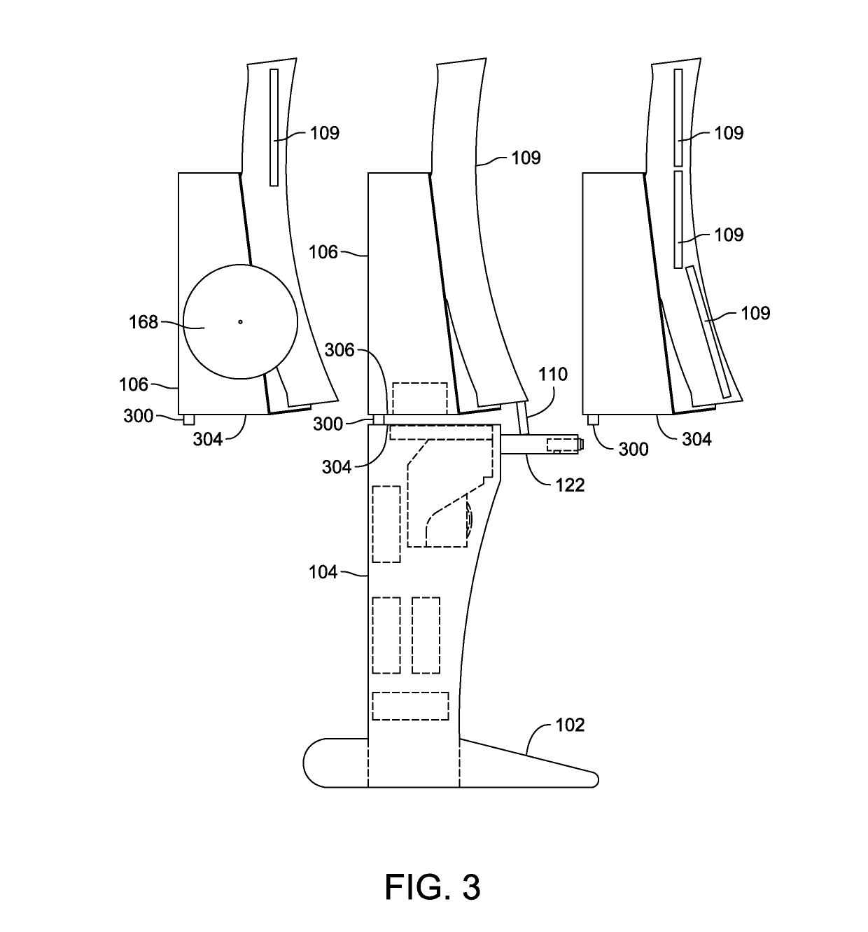

FIG. 3 is a side elevation view of a column 104 and three examples of game cabinet 106. In one embodiment, a lower portion of game cabinet 106 includes mechanical reels while an upper portion of game cabinet 106 includes a video display panel 109. A mating connector 300 is configured to pass control, sensor instrument, and power signals between column 104 and game cabinet 106. Each of the examples of game cabinet 106 include a first mounting flange 304 configured to engage a complementary second mounting flange 306 on column 104. Mounting flanges 304 and 306 are operable to secure game cabinet 106 to column 104 and to be able to be relatively quickly disengaged from column 104 to interchange various embodiments of game cabinet 106. Mounting flanges may include fasteners 304 and 306 to facilitate secure fastening of game cabinet 106 to column 104 and/or may include auxiliary fastening means, such as, but not limited to drift pins, bayonet or other slidably engaging surfaces, clamps, or inclined surfaces configured to provide a friction fit or an interference element configured to lock game cabinet 106 to column 104.

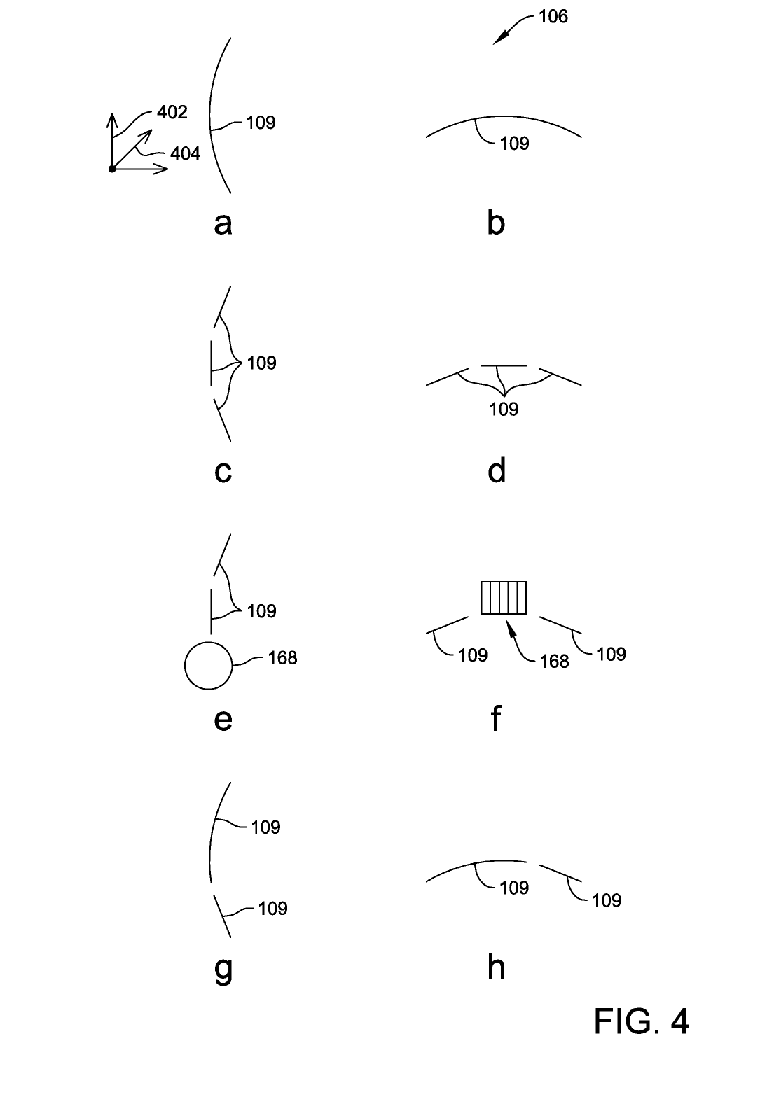

FIG. 4 is an illustration of configurations of game cabinet 106 in accordance with an example embodiments of the present disclosure. Configuration (a) represents a side view of a single video display panel 109 that includes a curved cross-section illustrated in a portrait orientation where a vertical dimension 402 is greater than a horizontal dimension 404. Configuration (b) represents a plan view of single video display panel 109 that includes a curved cross-section illustrated in a landscape orientation where vertical dimension 402 is less than horizontal dimension 404. Configuration (c) represents a side view of a plurality of video display panels 109 illustrated in a portrait orientation. Configuration (d) represents a plan view of plurality of video display panels 109 illustrated in a landscape orientation. Configuration (e) represents a side view of a plurality of video display panels 109 and mechanical reels 168 illustrated in a portrait orientation. Configuration (f) represents a plan view of plurality of video display panels 109 and mechanical reels 168 illustrated in a landscape orientation. Configuration (g) represents a side view of a plurality of video display panels 109 illustrated in a portrait orientation where one video display panel 109 is relatively larger than the other video display panel 109. Configuration (h) represents a plan view of a plurality of video display panels 109 illustrated in a landscape orientation where one video display panel 109 is relatively larger than the other video display panel 109.

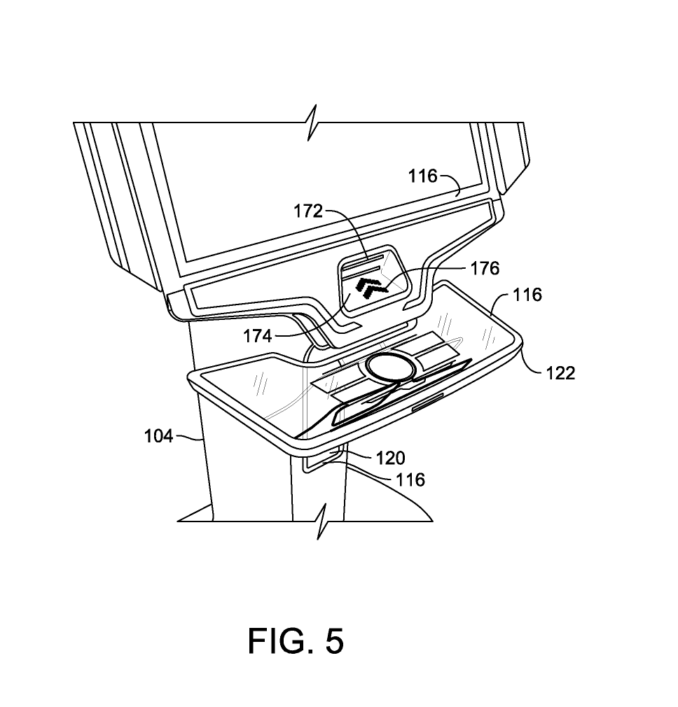

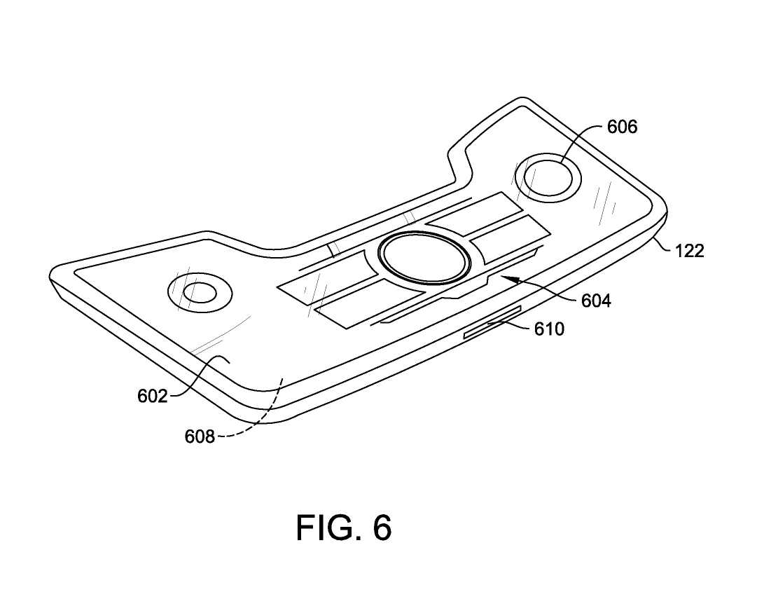

FIG. 5 is a perspective view of a lower portion of game cabinet 106 in accordance with an example embodiment of the present disclosure. FIG. 6 is an enlarged perspective view of button deck 122. In the example embodiment, button deck 122 includes an upper input surface 602 that may be embodied in a touchscreen surface or may be embodied in a combination of touchscreen elements 604 and mechanical input devices 606. For example, upper input surface 602 may include touchscreen elements for inputting various wager amounts, a “service” call button, a “cash-out” button, and other input requirements and also include a mechanical “spin” button 606. Touchscreen elements 604 may be isolated to certain areas of surface 602 and may be fixed in their function. However, in some embodiments, touchscreen elements 604 may be relocatable on surface 602 and may be reconfigurable to perform different functions during different portions of a game or for different games, such as when game cabinet 106 is interchanged. In one embodiment, button deck 122 is at least partially transparent or translucent, which permits a user to see through button deck 122, permits light from sources below button deck 122 to be seen by the user, and gives an appearance of mechanical “spin” button 606 and touchscreen elements 604 floating in front of the user.

Upper input surface 602 also may include an element 608 configured to control an opacity of button deck 122. Element 608 may comprise a liquid crystal display (LCD) element or other element configured to be electrically controlled to alter its transmissive properties. Element 608 may be configured to control opacity of button deck 122 as a whole or may be configured to control smaller regions of button deck 122 to present graphical objects to the user.

Button deck 122 also includes a card reader 610 for player tracking and communication. Card reader 610 is a part of a player tracking system that receives a player tracking card inserted and removed by the user. Card reader 610 transfers information stored on a player card to gaming machine 100. Gaming machine 100 is configured to provide player information on a player information portion (not shown in FIG. 6) of video display panel 109. In one embodiment, the player information portion is a reserved area that can be observed during game play. In other embodiments, the player information portion is overlaid onto a game screen during play or between games. When the player information portion is reserved, player information may only be displayed during predetermined times or when activated by the user. In other embodiments, the player information is dimmed or grayed out so as not to detract from the appearance of the game during game play.

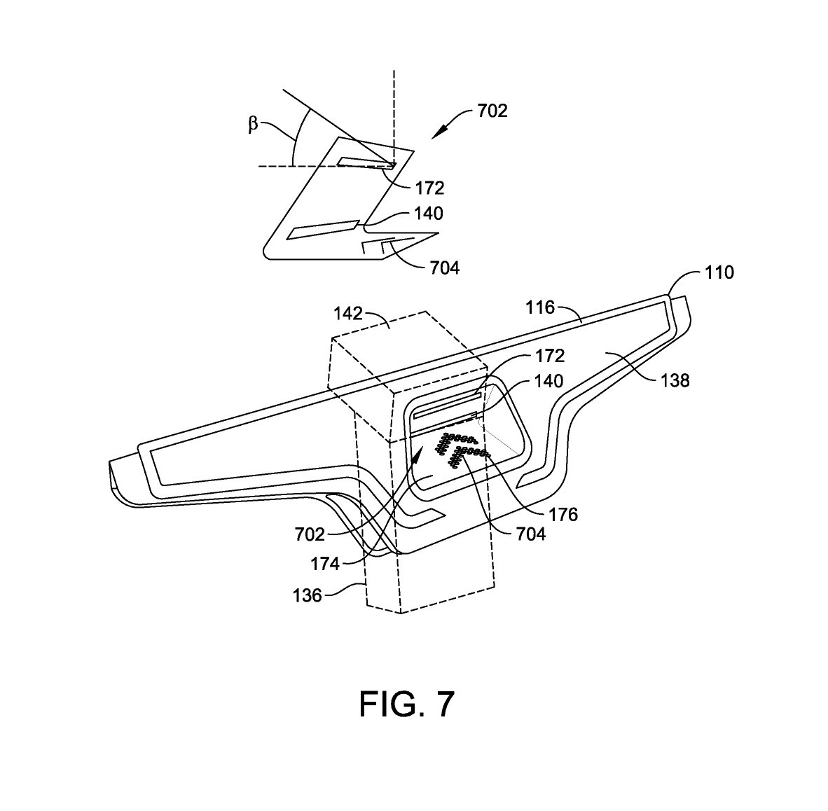

FIG. 7 is an enlarged perspective view of first user interface 110. An inset illustrates a side elevation view of an opening 702 of first user interface 110. In the example embodiment, printer slot 172 is recessed within an opening 702 of first user interface 110 such that printer slot 172 is not visible to the user during game play. Value acceptor slot 140 is positioned within opening 702 towards a rearward edge of receiving surface 174. Receiving surface 174 provides a flat stable platform for guiding currency bills and vouchers into value acceptor slot 140. Graphical output device 176 provides an indication of a location of value acceptor slot 140 and guidance as to an expectation of gaming machine 100 with respect to receiving items through value acceptor slot 140 or discharging items through printer slot 172. For example, an arrow object 704 pointing inwardly may be displayed using graphical output device 176 when gaming machine 100 is expecting an introduction of a value item into value acceptor slot 140 and may display an outwardly pointing arrow object (not shown) when gaming machine 100 is printing a voucher or coupon.

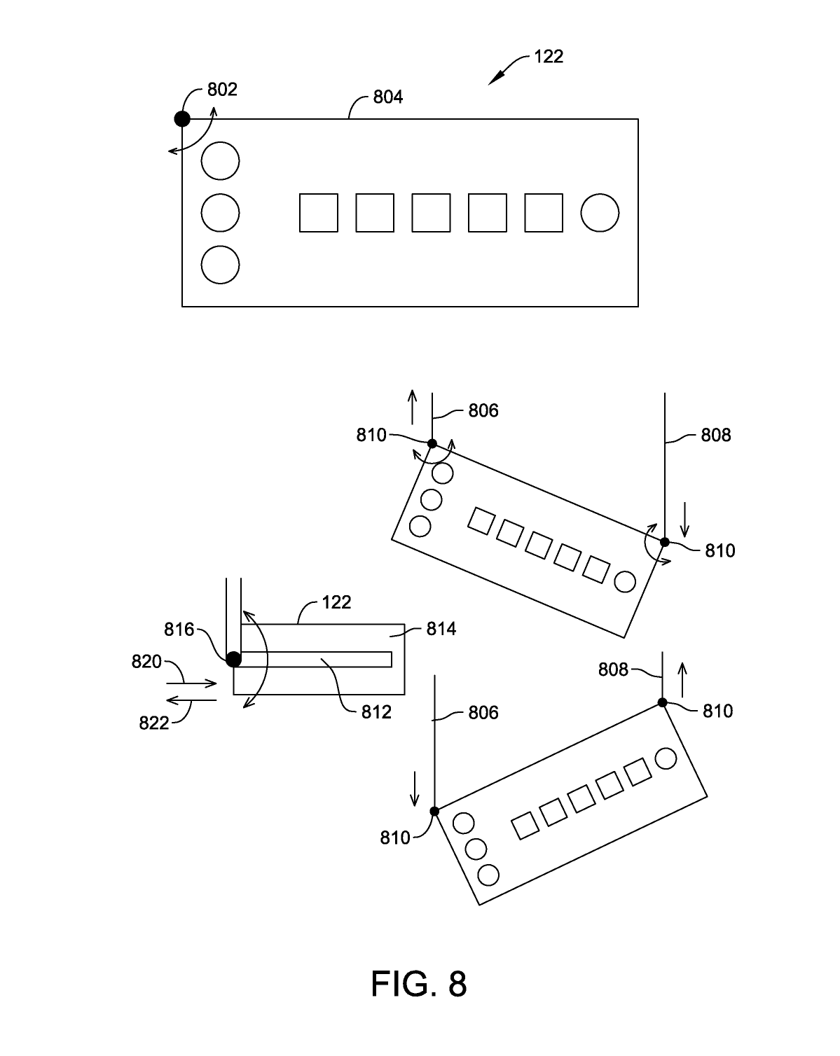

FIG. 8 is an illustration of embodiments of connections of button deck 122 to column 104. In a first alternative embodiment, button deck 122 is pivotally coupled to column 104 through a pivot point 802 located along a rear edge 804 of button deck 122. In the example embodiment, pivot point 802 is positioned in a corner of button deck 122, however pivot point 802 can be located at any position along rear edge 804. A second alternative embodiment includes a first support arm 806 and a second support arm 808. In the example embodiment, support arms 806 and 808 are telescoping in that one of first support arm 806 and second support arm 808 may be extended at different rates and/or distances to permit button deck 122 to be angled with respect to column 104. Such an orientation may be beneficial to, for example, a user that is not positioned directly in front of gaming machine 100. To support such movement, a connection point 810 between first support arm 806 and second support arm 808 and button deck 122 is pivotable about connection point 810. A third alternative embodiment is illustrated where a track 812 along an underside 814 of button deck 122 is configured to receive a pivotable knob 816 coupled to an arm 818 extending from column 104. During operation, button deck 122 can be translated laterally along track 812 in a first direction 820 or a second direction 824 and/or rotated about knob 816 at any point along track 812.

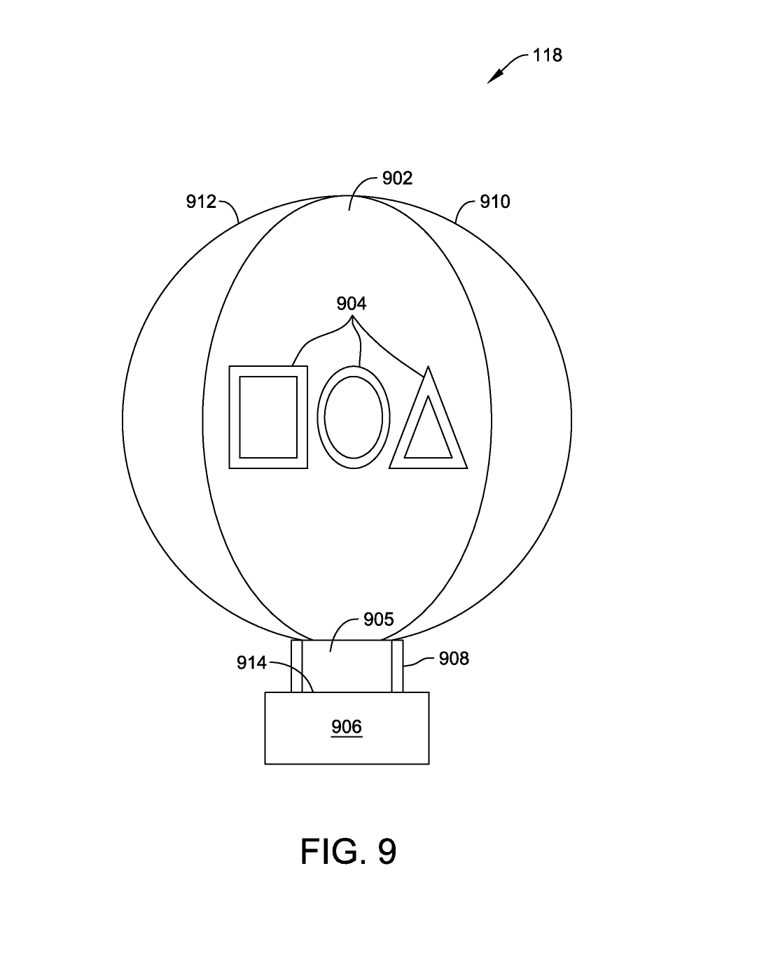

FIG. 9 is a perspective view of beacon light 118. In the example embodiment, beacon light 118 includes a planar graphic substrate 902 that includes indicia 904, for example, but not limited to text characters, pictures, shapes, or icons. In various embodiments, indicia 904 is embossed onto graphic substrate 902 or may be cut into graphic substrate 902. Graphic substrate 902 includes a connection tab 905 configured to couple to a light source 906 and support clamp 908. A first transparent hemispherical globe portion 910 and a second translucent or opaque hemispherical globe portion 912 are joined at graphic substrate 902. During operation, light from light source 906 is transmitted through an edge 914 of connection tab 905 into a body of graphic substrate 902. The light then highlights indicia 904 to increase a visibility of indicia 904. Light source 906 may be controlled by gaming machine 100 to coordinate the operation of light source 906 with game play or for attracting users when gaming machine 100 is idle.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A gaming machine comprising:
a base comprising a width having a first length dimension and a depth having a second length dimension;
a columnar pedestal extending vertically from said base, said pedestal comprising a width having a third length dimension and a depth having a fourth length dimension, the first length dimension being greater than the third length dimension, the second length dimension being greater than the fourth length dimension; and
a game cabinet comprising:
a gaming display comprising at least one of a single video display panel, a plurality of video display panels, and a combination of mechanical reels and one or more video display panels;
a mating flange configured to releasably mount to a complementary pedestal flange positioned at an upper edge of said pedestal; and
one or more mating plugs configured to engage a complementary one or more mating plugs positioned proximate said mating flanges, said mating plugs configured to join respective signal and power conduits between said pedestal and said game cabinet.

2. The gaming machine of claim 1, wherein the third length dimension is less than seventy-five percent of the first length dimension.

3. The gaming machine of claim 1, wherein the third length dimension is less than forty percent of the first length dimension.

4. The gaming machine of claim 1, wherein the fourth length dimension is less than seventy-five percent of the second length dimension.

5. The gaming machine of claim 1, wherein the fourth length dimension is less than forty percent of the second length dimension.

6. The gaming machine of claim 1, wherein the third length dimension is less than seventy-five percent of the fourth length dimension.

7. The gaming machine of claim 1, wherein the third length dimension is less than forty percent of the third length dimension.

8. The gaming machine of claim 1, further comprising a user interface comprising:
a value acceptor slot positioned at a rear edge of a flat receiving surface, the flat receiving surface including a graphical output device configured to indicate an expected action to a user; and
a printer slot oriented in a downward angle of about 0° to about 90° with respect to horizontal.

9. The gaming machine of claim 8, wherein the graphical output device configured to display at least one of a static graphic item and a dynamic graphic item related to a state of said gaming machine.

10. The gaming machine of claim 8, wherein the graphical output device comprises at least one of an array of addressable lights and a video display panel.

11. The gaming machine of claim 1, further comprising:
a button deck adjustably coupled to said pedestal;
a player tracking card reader positioned within the button deck and accessible through a slot in a front edge of the button deck; and
a player tracking display area of said gaming display configured to display player tracking information.

12. The gaming machine of claim 8, further comprising a first side panel device coupled to a first side of said frame and a first side panel device coupled to a second side of said frame opposite said first side, said first and second side panels including a backlit display panel.

13. A gaming machine comprising:
a gaming display comprising a display frame surrounding a display area;
a first side panel device coupled to a first side of said frame and a second side panel device coupled to a second side of said frame opposite said first side, said first and second side panels including a touchscreen video display panel;
a beacon light comprising:
a planar substrate comprising an outer peripheral edge;
a light source configured to illuminate an interior of said substrate through at least a portion of the outer peripheral edge;
a first transparent hemispherical member comprising an edge configured to mate to the outer peripheral edge; and
a second hemispherical member comprising an edge configured to mate to the outer peripheral edge, said second hemispherical member formed of a material that is at least one of translucent and opaque.

14. The gaming machine of claim 13, wherein said display area comprises at least one of a single video display panel, a plurality of video display panels, and a combination of mechanical reels and one or more video display panels.

15. The gaming machine of claim 13, wherein said beacon light is configured to translate laterally across an upper edge of said gaming display.

16. The gaming machine of claim 13, wherein said planar substrate comprises indicia formed in a surface of said planar substrate, the indicia configured to interact with the light illuminating the interior of said planar substrate to illuminate a border surrounding each edge of the indicia.

17. The gaming machine of claim 13, further comprising a pedestal configured to couple to gaming display through a mechanical coupling flange, signal coupling connectors, and at least one power conduit connector.

18. The gaming machine of claim 17, further comprising a user interface comprising a unitary value acceptor and printer bezel, said bezel comprising a flat receiving surface configured to direct at least one of currency and vouchers into a first value acceptor slot proximate an edge of said receiving surface, said bezel comprising a second downwardly oriented printer slot positioned above said value acceptor slot and configured to direct items exiting said printer towards said receiving surface.

19. A gaming machine system comprising:
a pedestal comprising:
a button deck adjustably coupled to said pedestal, said button deck including a pair of extendable arms, each arm coupled at one end to said pedestal and at a second end to said button deck, said button deck extendable away from and towards said pedestal; and
a player tracking card reader positioned within the button deck and accessible through a slot in a front edge of the button deck; and
a plurality of interchangeable gaming displays selectable such that one of the plurality of gaming displays is mounted to said pedestal at a time, said plurality of gaming displays comprising:
a single video display panel oriented in at least one of a portrait and a landscape orientation;
a plurality of video display panels oriented in at least one of a portrait and a landscape orientation; and
a combination of mechanical reels and one or more video display panels;
a mating flange configured to releasably mount to a complementary pedestal flange positioned at an upper edge of said pedestal; and
one or more mating plugs configured to engage a complementary one or more mating plugs positioned proximate said mating flanges, said mating plugs configured to join respective signal and power conduits between said pedestal and said game cabinet; and
a player tracking display area of said plurality of interchangeable gaming displays configured to display player tracking information, said player tracking display area displayed on one of said video display panels.

20. The gaming machine system of claim 19, wherein said pedestal includes an actuator configured to facilitate extending said button deck away from and towards said pedestal.
